(19) United States
(12) Patent Application Publication
(10) Pub. No.: US 2022/0079835 A1
(43) Pub. Date: Mar. 17, 2022

(54) Vertical Massage Device and Method of Use

(71) Applicant: Janice Kay Smith, Chicago, IL (US)

(72) Inventor: Janice Kay Smith, Chicago, IL (US)

(21) Appl. No.: 17/536,849

(22) Filed: Nov. 29, 2021

Related U.S. Application Data
(63) Continuation of application No. 15/907,381, filed on Feb. 28, 2018.

(51) Int. Cl. A61H 15/00

(52) U.S. Cl. CPC A61H 15/0078; A61H 2201/1207; A61H 23/02; A61H 2015/0064; A61H 2201/5097; A61H 2201/1673

(57) ABSTRACT

The present disclosure relates generally to a massage device, for example, suitable for massaging the muscles of a person. The present disclosure relates more particularly to a vertical massage device including a vertical track, a carriage coupled to the vertical track, a massage component disposed on the carriage, and a drive that is connected to the carriage and configured to move the carriage along the vertical track.

### CROSS REFERENCE TO RELATED APPLICATIONS

The present application is a continuation of U.S. patent application Ser. No. 15/907,381, filed on Feb. 28, 2018 and entitled “Vertical Massage Device and Method of Use” which is hereby incorporated by reference in its entirety.

### BACKGROUND OF THE DISCLOSURE

### 1. Field of the Disclosure

The present disclosure relates generally to a massage device, for example, suitable for massaging the muscles of a person. The present disclosure relates more particularly to a device configured to move along one or more muscles so as to provide a massage.

### 2. Technical Background

Tightness in muscles or fascia can jeopardize a person's overall health. Such tightness can cause inflammation in the muscles, fascia and neighboring joints, which may lead to discomfort in the affected areas. Pain from muscle and fascia tightness in the ankles, knees, hips, back, and pelvis often affects posture, function, movement, strength, and endurance of the body.

Left untreated, tightness can lead to more serious injuries. For example, tightness of the iliotibial band (IT), calf, hamstrings, quadriceps, hip flexors, abductors and adductors can cause falls, tears and strains. In severe cases, treatment of the affected tissue may require injections or even surgery.

To reduce tightness in muscles and fascia, medical practitioners often recommend massaging the tight tissue to alleviate tension and thereby reduce inflammation. A popular method to reduce tightness, particularly in the back and legs, involves a person lowering herself to a horizontal position near the floor, placing the affected tissue on top of a ball or foam roller, and rolling the tissue back and forth over the ball or foam roller. Using his body weight, the person can press affected tissue onto the ball or foam roller and use the rolling motion to alleviate the tension. While this method can be affective, it has numerous drawbacks. First, adjusting the force applied to the tissue requires the person to hold a portion of his body weight off the floor. For many people, holding their body weight in this position is too strenuous, and they may be unable to maintain the position for the amount of time necessary to promote relief. Accordingly, many people will apply more pressure to the affected tissue than necessary, which can cause significant discomfort and pain.

An alternative method of alleviating tightness in muscles and fascia involves the use of a hand-held roller or other massage device that is moved by the user over the affected tissue. This method also has drawbacks, as it requires the user to contort her body in various positions. While the user is sitting or standing, she must compromise muscles in the torso by bending or twisting in order to reach the affected muscles. Further, it may be difficult in such a position to supply even pressure over the muscle, or even to reach the entirety of the muscle, which is often required to fully alleviate tension.

The present inventor has recognized that there is a need for a massage device that can target muscles and reduce tension more effectively and that is easier to use.

### SUMMARY OF THE DISCLOSURE

In one aspect, the present disclosure provides a vertical leg massager comprising:

a vertical track;

a carriage coupled to the vertical track;

a massage component disposed on the carriage; and

a drive connected to the carriage and configured to move the carriage along the vertical track.

In another aspect, the disclosure provides a massage method comprising:
providing a vertical massager including:
   a vertical track,
   a carriage coupled to the vertical track,
   a massage component disposed on the carriage, and
   a drive connected to the carriage and configured to move the carriage along the vertical track;
pressing a leg of a standing user against the massage component; and
operating the drive so as to move the carriage along the vertical track and massage the leg.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a schematic perspective view of a massage device according to an embodiment of the disclosure;

FIG. 2 is a schematic side view of the massage device of FIG. 1 with a user operating the device;

FIG. 3 is a schematic top cross-sectional view of the massage device of FIG.1;

FIG. 4 is a schematic perspective view of a massage device according to another embodiment of the disclosure;

FIG. 5 is a schematic side view of a massage device according to another embodiment of the disclosure;

FIG. 6 is a schematic side view of a massage device according to yet another embodiment of the disclosure;

FIG. 7 is a schematic side view of a massage device according to another embodiment of the disclosure;

FIG. 8 is a schematic side view of a massage component in accordance with an embodiment of the disclosure;

FIG. 9 is a schematic side view of a massage component in accordance with another embodiment of the disclosure;

FIG. 10 is a schematic side view of a massage device according to another embodiment of the disclosure;

FIG. 11 is a schematic front view of the massage device of FIG. 10;

FIG. 12 is a schematic side view of a massage device according to yet another embodiment of the disclosure;

FIG. 13 is a schematic front view of the massage device of FIG. 12;

FIG. 14 is a schematic side view of a portion of a massage device according to an embodiment of the disclosure in a first position; and

FIG. 15 is a schematic side view of a portion of the massage device of FIG. 14 in a second position.

### DETAILED DESCRIPTION

As described above, the present inventor has noted that conventional massage devices and methods can be difficult to use and, even when effective, can lead to other problems. The present inventor has developed a massage device that is easier to use and can effectively massage muscles and other tissue without compromising proper form and without discomfort or fatigue.

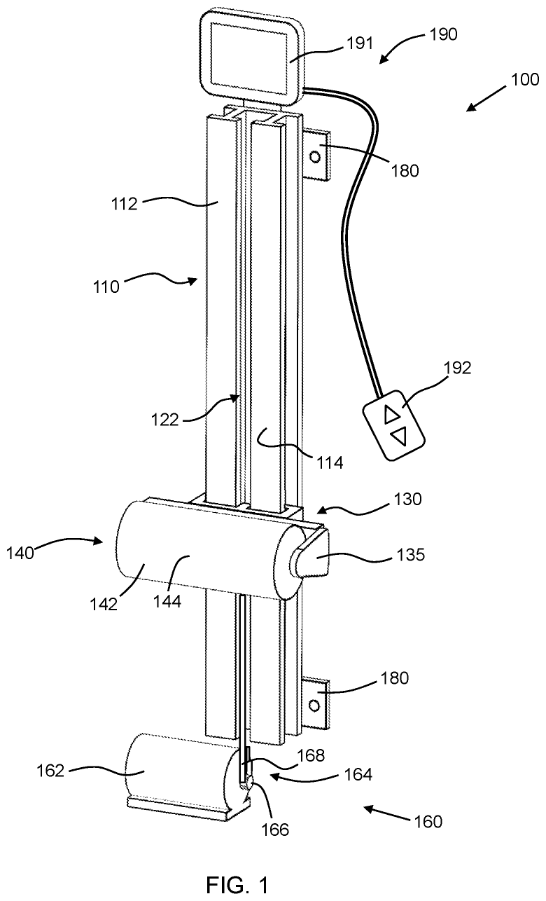

Accordingly, one aspect of the disclosure is a vertical leg massage device including a vertical track, a carriage coupled to the vertical track, a massage component disposed on the carriage, and a drive that is connected to the carriage and configured to move the carriage along the vertical track. Such a massage device is shown in FIGS. 1-3. Massage device 100 includes vertical track 110, carriage 130 coupled to track 110, massage component 140 disposed on carriage 130, and drive 160 connected to carriage 130. Carriage 130 is movable along vertical track 110 in order to transport massage component 140 up and down the track. In turn, drive 160 operates to impart motion to carriage 130 in order to provide the up and down movement along track 110. In operation, a user places a muscle or other tissue against massage component 140 and operates drive 160 in order to move carriage 130 and massage component 140 and to impart a massaging motion to the user's tissue.

In certain embodiments as otherwise described herein, the vertical track is straight. For example, track 110 is a straight track and allows movement of carriage 130 in only two opposing directions, namely up and down. In particular, track 110 is aligned with gravity such that carriage 130 is confined to a vertical axis as it travels along the track. In other embodiments, the track includes small curves in order to match the contours of a person's body.

In such an embodiment, the carriage still moves substantially along the direction of a straight axis, yet the carriage can deviate from that axis in the location of the curves. For example, in certain embodiments, a lower portion of the track includes a shallow concave curve to accommodate a user's calf. In other embodiments, an upper portion of the track includes a convex curve to accommodate a user's lower back. In still other embodiments, the track includes multiple small curves corresponding to various contours of the user's body.

In certain embodiments, the vertical track is a section of a longer track with additional curves. For example, the vertical track may be a vertical section of a track that also includes horizontal components on either or both ends of the vertical section. For example, these sections may be used for mounting the track to a support surface and be inaccessible to the carriage. Or the carriage may travel along these curved sections, which are used for massaging other parts of the user's body.

The term vertical, as used herein, refers to a direction that is substantially aligned with the direction of gravity. In some embodiments, an axis of the vertical track is within 30 degrees of the direction gravity, for example, within 15 degrees, within 5 degrees or even within 2 degrees of the direction of gravity.

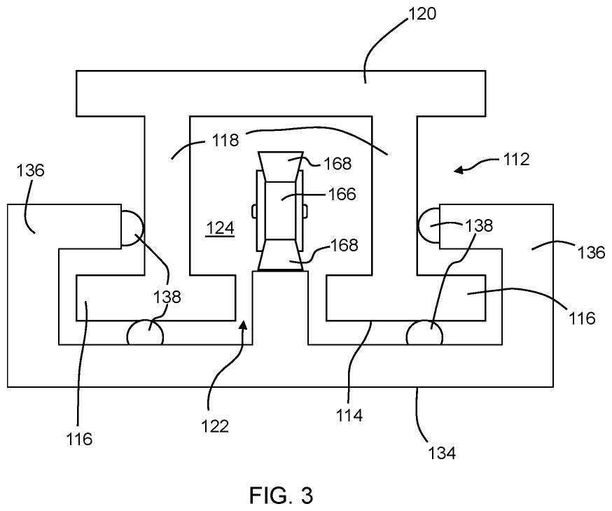

In certain embodiments as otherwise described herein, the track includes at least one rail, and the carriage includes rollers that secure the carriage on the rail and allow rolling interaction between the carriage and the rail as the carriage moves along the track. For example, track 110 includes rail 112 with a hollow interior. Rail 112 includes a riding surface 114 and outwardly extending flanges 116 on opposing lateral sides of track 110 (shown in FIG. 3). Two webs 118 extend backward from flanges 116 to a base 120 that is opposite riding surface 114. The riding surface 114 includes an opening 122 that provides access to the hollow interior 124 within rail 112, as described in more detail below. In cooperation with rail 112, carriage 130 includes a platform 134 that runs along riding surface 114 and stabilizing legs 136 that extend around flanges 116 to hold carriage 130 securely on track 110. Carriage 130 further includes rollers 138 that run against sections of rail 112 to provide smooth relative motion between carriage 130 and track 110. While the depicted rollers 138 are rolling balls, some embodiments include wheels or other types of rollers.

As will be understood by a person of ordinary skill in the art, the carriage and rail can have various configurations of flanges, stabilizing legs and rollers to secure the carriage to the track while allowing the carriage to move smoothly thereon. For example, while the carriage 130 in massage device 100 wraps around a portion of track 110 and has stabilizing components that engage an outer surface of the track, in other embodiments the carriage includes stabilizing components that are disposed inside the track, such that the track wraps around the carriage.

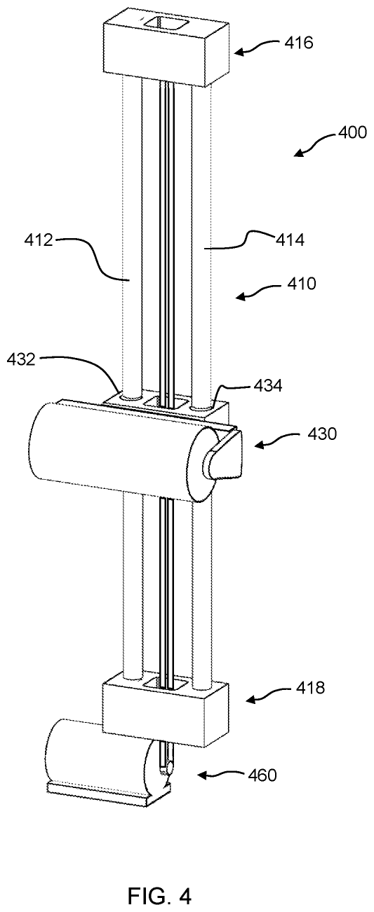

In certain embodiments as otherwise described herein, the track includes a rod that extends through an opening in the carriage. For example, massage device 400, shown in FIG. 4 includes track 410 that comprises a first rod 412 and a second rod 414. Carriage 430 includes first and second openings 432, 434 through which rods 412 and 414 of track 410 extend. Within the first and second openings 432, 434, the carriage also includes rollers, such as bearings, that allow a smooth rolling interaction between the carriage 430 and the rods 412, 414. In other embodiments, the carriage openings have a sliding engagement with the rods of the track. For instance, in some embodiments the openings in the carriage are lined with respective bushings. The bushings may be made of a low friction material that promotes smooth movement between the carriage and the track, as will be appreciated by those of ordinary skill in the art. While track 410 includes two rods, in other embodiments the track includes a single rod, or more than two rods.

To secure the rods 412, 414, track 410 further includes upper and lower receiving structure 416, 418 that hold the respective ends of rods 412 and 414 in place. Lower receiving structures 418 is a single structure that includes an aperture allowing portions of drive 460 to pass therethrough. In other embodiments, the lower receiving structure can be formed by separate components that receive each rod of the track individually.

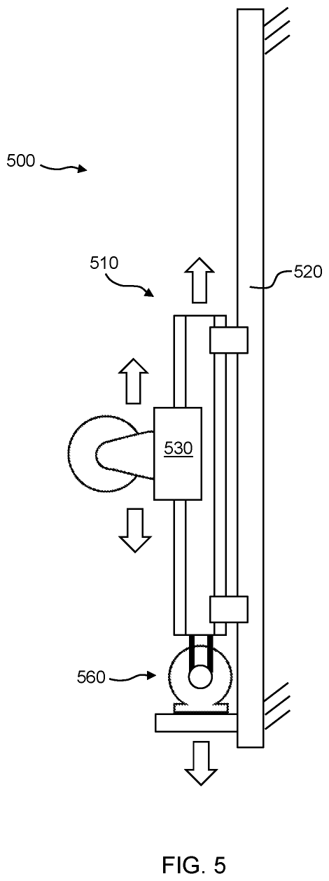

In certain embodiments as otherwise described herein, the track is disposed on a structural support and the track is moveable in a vertical direction along the structural support. For example, in massage device 500, shown in FIG. 5, track 510 is disposed on support structure 520 that is attached to a wall. In addition to carriage 530 being movable along track 510, track 510 is also movable up and down along support structure 520. In massage device 500, the entire drive 560 is movable along with track 510 on the support structure 520. In other embodiments, portions of the drive are fixed in place while other portions that are coupled to the carriage move along with the track. For example, in some embodiments, the drive is coupled to the carriage and spans the entire length of the support structure, allowing the track to move up and down the support structure without being constrained by components of the drive.

In certain embodiments as otherwise described herein, the drive includes an electric motor that imparts movement of the carriage along the track. For example, in massage device 100, shown in FIGS. 1-3, drive 160 includes electric motor 162 and a linkage 164 that is attached to the carriage 130. The term linkage, as used herein, is broad and includes any mechanical components that transform motion of one type or at one location into a new type of motion or at a new location. For example, the term linkage can include gears, belts, leadscrews and other such mechanical components as would be appreciated by those of ordinary skill in the art. Electrical motor 162 converts electrical power into a rotational motion that powers movement of carriage 130 through the linkage 164. In other embodiments the drive is propelled by a hydraulic or a pneumatic system. Still in other embodiments, the drive includes a handle or pedal that is operated by the user. The handle or pedal is coupled to the carriage through a linkage that transforms movement of the handle or pedal to a vertical movement of the carriage along the track.

In certain embodiments the electric motor has a power rating in a range of 0.1 to 0.5 horsepower, for example 0.2 to 0.3 horsepower, for example about 0.25 horsepower. Such a power rating is sufficient to move the carriage with a force applied against the massage component within a normal operating range. In certain embodiments, the electric motor has a greater or smaller power rating.

In certain embodiments as otherwise described herein, the drive includes a wheel coupled to the electric motor and a belt or chain engaging the wheel. The wheel is configured to be driven by the electric motor. The belt or chain is disposed in a loop that spans the height of the vertical track. Further, the carriage is mounted on the belt or chain so as to move up or down along the vertical track as the belt or chain is driven by rotation of the wheel. For example, linkage 164 in massage device 100 includes a wheel 166 in the form of a sheave that is coupled to a belt 168. In other embodiments, the wheel is a sprocket or gear and the linkage includes a toothed belt or a chain. A portion of belt 168 is attached to carriage 130 so that conveyance of belt 168 by sheave 166 moves carriage 130. In order for belt 168 to drive the movement of carriage 130 along the entire height of track 110, the belt extends upward to span the length of the vertical track. Belt 168 spans the length of track 110 in that it extends from an area at the bottom of track 110 to an area at the top of track 110.

In some embodiments, the loop that includes the belt or chain has a uniform construction along its length. For example, the entire loop is in the form of a toothed belt. In other embodiments, the belt or chain is confined to a portion of the loop and the remaining portion of the loop is provided by a tension line, such as a cord. With movement of the carriage being confined to length of the track, in many embodiments there is no need for the entire loop to engage the wheel. Accordingly, in some embodiments the belt or chain portion of the loop is confined to a certain section.

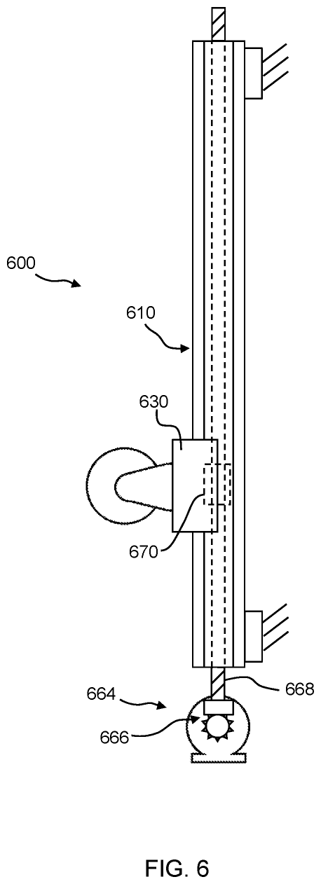

In certain embodiments as otherwise described herein, the drive includes a screw coupled to the electric motor and configured to be rotated by the electric motor. The screw spans a height of the vertical track and a rotationally fixed nut is configured to move up and down with rotation of the screw. The carriage is attached to the nut such that movement of the nut correlates to movement of the carriage. For example, the linkage 664 of massage device 600, shown in FIG. 6, includes leadscrew 668 that is driven with a gearing mechanism 666. The gearing mechanism 666 includes a gear coupled to electric motor 662 and a mating gear coupled to leadscrew 668. As a result, rotation of the electric motor results in a corresponding rotation of leadscrew 668. The leadscrew 668 spans the height of the vertical track 610 and is held in place at either end by bearing members. A nut 670 is attached to carriage 630 and encompasses leadscrew 668. In massage device 600, nut 670 slides within track 610 and is thereby prevented from rotating with leadscrew 668. Accordingly, as leadscrew 668 rotates, the threads of the screw push nut 670 and the associated carriage in a vertical up or down direction, depending on the direction of rotation of leadscrew 668. As will be appreciated by those of ordinary skill in the art, the engagement between the leadscrew and the nut and between the nut and the track can include rollers, such as ball bearings, to ensure smooth movement of all of the components of the linkage. While nut 670 in massage device 600 is prevented from rotating by track 610, in other embodiments a separate structure is used to constrain the rotational movement of the nut.

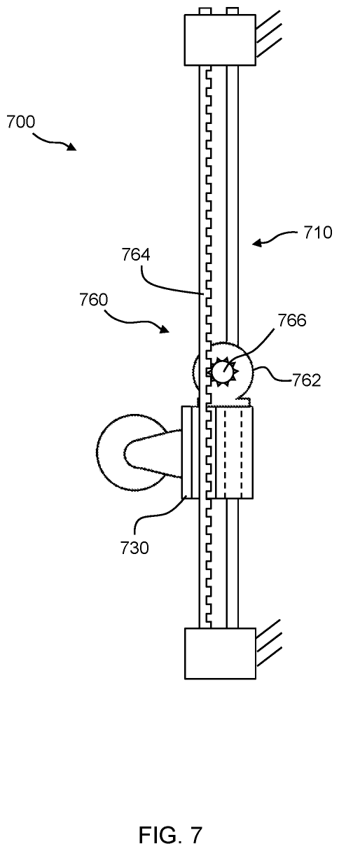

In certain embodiments as otherwise described herein, the drive includes a pinion mounted on the carriage and coupled to the electric motor. The pinion is configured to be rotated by the electric motor. The drive also includes a rack spanning the height of the vertical track that is engaged by the pinion such that rotation of the pinion moves the pinion along the rack thereby imparting motion to the carriage along the vertical track. A massage device including such a drive is shown in FIG. 7. Massage device 700 includes a drive 760 with electric motor 762 and rack and pinion components 764, 766. Pinion 766 is mounted on electric motor 762 such that operation of the motor rotates the pinion. In turn, pinion 766 engages rack 764 such that the teeth of pinion 766 interlock with the corresponding teeth of rack 764 and rotation of pinion 766 results in movement along rack 764. Further, rack 764 spans the length of track 710 such that movement of pinion 766 along rack 764 corresponds to movement along track 710. In the case of massage device 700, the pinion is fixed with respect to the carriage. Accordingly, as the electric motor turns pinion 766, the pinion and carriage both move along rack 764 and likewise along track 710.

In certain embodiments as otherwise described herein, the drive includes an electric motor that is mounted to the carriage so as to move with the carriage along the track. For example, electric motor 762 is attached to carriage 730. As electric motor 762 turns pinion 766, thereby causing the pinion to move along rack 764, the electric motor and carriage move together along track 710. In other embodiments, the electric motor is fixed in place. For example, in massage devices 100, 400, 500 and 600, the electric motors are fixed in place. As will be appreciated by those of ordinary skill in the art, the electric motors may be attached to a support structure such as the floor or a wall using fastening mechanisms or other attachment configurations.

In certain embodiments as otherwise described herein, portions of the drive are encompassed within an opening in the track. For example, in massage device 100, belt 168 passes through a channel formed by hollow interior 124 within rail 112 (see FIG. 3). Likewise, in massage device 600, leadscrew 668 passes through a similar channel within the track. In other embodiments, the drive and the track are spaced from one another. For example, in some embodiments, the drive is attached to one section of the carriage, while another section of the carriage is coupled to the track.

In certain embodiments as otherwise described herein, the massage component includes a roller that is rotatably coupled to the carriage. For example, the massage component 140 of massage device 100 includes roller 142. Carriage 130 includes two arms 135 that hold opposing ends of roller 142 through a rotatable engagement, as will be appreciated by those of ordinary skill in the art, for example using bearings. Arms 135 allow roller 142 to rotate about an axis that is perpendicular to the axis of movement along track 110.

In certain embodiments as otherwise described herein, the roller is cylindrical and rotates about a central axis of the cylindrical shape. In such an embodiment, the peripheral surface 144 of the roller curves around the axis of rotation, but is straight along the length of the axis of rotation. For example, roller 142 in massage device 100 in cylindrical in shape. In other embodiments the roller includes an outer surface that includes curves both around the axis of rotation and along the axis of rotation. For example, in some embodiments the roller is spherical in shape. In other embodiments the roller has an undulating surface such that the roller has a varying diameter along the length of the axis of rotation.

In certain embodiments as otherwise described herein, the roller includes a peripheral surface formed of a complaint material. As will be appreciated by those of ordinary skill in the art, the material may have a stiffness that is high enough to provide a massaging force when applied to soft tissue, but low enough to yield when applied to bones or other harder tissue.

In certain embodiments as otherwise described herein, the complaint material is one of a closed-cell foam, a polyethylene foam, polystyrene, ethylene-vinyl acetate, rubber, synthetic rubber, or neoprene.

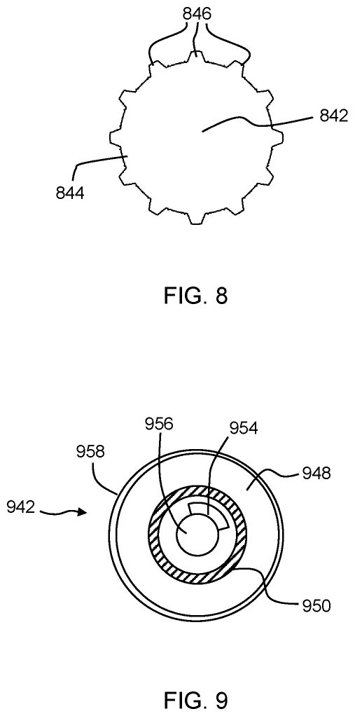

In certain embodiments as otherwise described herein, the peripheral surface of the roller includes a surface texture. In some embodiments the surface texture includes a series of protrusions or ridges arranged around the peripheral surface. The protrusions and ridges may be formed in a variety of different shapes, having a rounded or polygonal cross section. In certain embodiments the ridges extend along the length of the roller, while in other embodiments the ridges extend circumferentially around the roller. Still in other embodiments, the ridges extend along a helical path. In some embodiments the surface texture includes ridges and protrusions. For example, roller 842, shown in FIG. 8, includes a number of radially extending protrusions 846 on peripheral surface 844.

In certain embodiments as otherwise described herein, the roller is freely rotatable. As such, any portion of the roller surface that contacts the user's body will roll against the user, thereby reducing friction between the user's body and the roller. Further, when the roller includes a surface texture, the textured components will be pressed into a specific location of the user's body and massage the targeted tissue, rather than rubbing against the user.

In certain embodiments as otherwise described herein, the roller includes an outer layer surrounding a core. In some embodiments, the core is hollow. In certain embodiments, the roller includes an outer layer formed of a compliant first material that surrounds an inner core of a second material, where the first and second materials are different. In certain embodiments the core is solid, while in other embodiments the core is a hollow shell. For example, roller 942 includes outer layer 948 and inner core 950, which is formed as a hollow shell.

In certain embodiments as otherwise described herein, the inner core is harder than the compliant material of the outer layer. As will be appreciated by those of ordinary skill in the art, the core can formed from a variety of different materials including polyvinyl chloride (PVC), polyphenylene, polycarbonate, polyethylene, polypropylene, polystyrene, polyurethane, metal (e.g., aluminum), or combinations thereof.

In certain embodiments as otherwise described herein, the roller includes a vibration motor. In some embodiments, the vibration motor is an eccentric rotating mass vibration motor. For example, roller 942 includes such an eccentric rotating mass vibration motor, which includes an eccentric mass 954 that is coupled to motor 956. As the motor rotates the eccentric mass, a vibration is imparted to the roller, as will be appreciated by those of ordinary skill in the art.

In certain embodiments, the roller includes a sheathing of fabric. As used herein, the term fabric includes textiles and sheet material commonly used in place of textiles, such as leather or synthetic leather. In some embodiments the sheathing is elastic so as to form a tight fit over the peripheral surface of the roller. For example, roller 942 includes sheathing 958 surrounding outer layer 948. In some embodiments, the sheathing is removable from the rest of the roller. Such a removable sheathing allows the roller to be kept clean by allowing easy laundering of the sheathing.

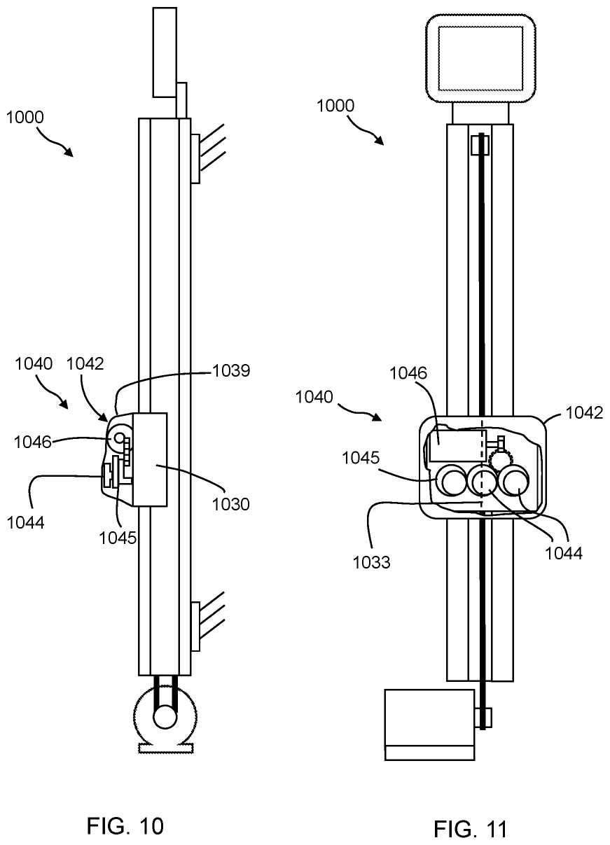

In certain embodiments, the massage component includes an actuator and a first massage head coupled to the actuator. The actuator is configured to move the first massage head in a path with respect to the carriage. The term actuator as used herein includes any component that imparts motion to another component. For example, in certain embodiments, the actuator is a motor. In other embodiments, the actuator is a hydraulic cylinder or a pneumatic cylinder. A massage device with such a massage component is shown in FIGS. 10 and 11. Massage device 1000 includes a massage component 1040 with an actuator and three massage heads 1044. Actuator 1042 includes an electric motor 1046, gearing mechanisms, and a rotatable wheel 1045 corresponding to each massage head 1044. Each of the massage heads 1044 is in the form of a disk that is coupled to the rotatable wheel. Each disk has a flat front surface to provide even pressure across the muscle that is being massaged.

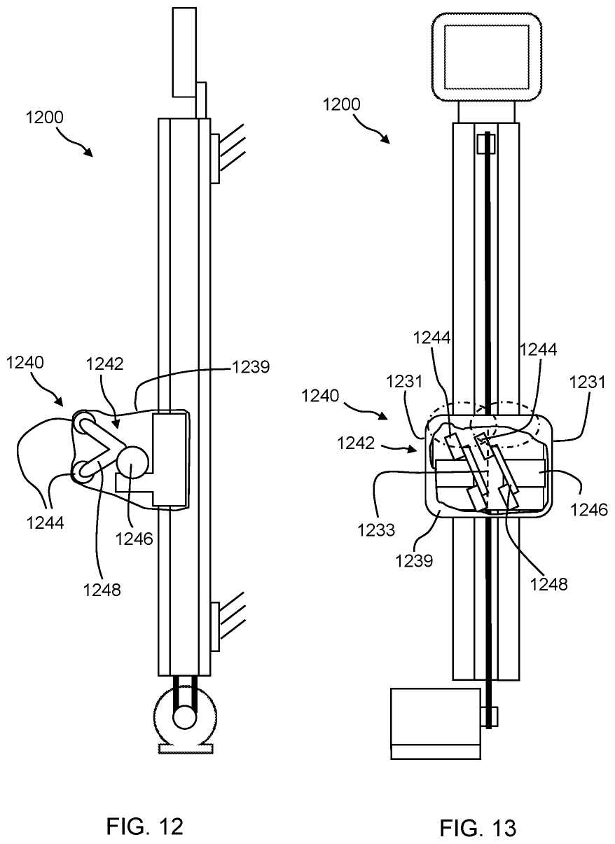

FIGS. 12 and 13 also show a massage device with an actuator and a first massage head coupled to the actuator. Massage device 1200 includes a massage component 1240 with two actuators 1242 each of which corresponds to a pair of massage heads 1244 (as shown in FIG. 13.) Actuators 1242 include electric motors 1246, gearing mechanisms, and arms 1248 that impart a series of motions to the massage heads, as will be appreciated by those of ordinary skill in the art. By using the actuators 1242, the massage heads are moved in a path with respect to the carriage. Thus, the carriage 1230 can move the massage heads along the track, but the actuators may further move the massage heads with respect to the carriage.

In certain embodiments as otherwise described herein, the path of the massage heads includes an elliptical component in a plane that is parallel to the axis of the vertical track. For example, massage heads 1044 move in a circle with the rotation of rotatable wheels 1045. Also, massage heads 1244 of massage device 1200 are moved by actuators 1242 in the elliptical paths shown in dashed lines in FIG. 12. In some embodiments, the actuators are configured to move the massage heads toward and away from the track, in a tapping motion. Such a motion can be accomplished by rotating the arms 1248 about a horizontal axis.

In certain embodiments as otherwise described herein, the carriage includes opposing lateral sides and a centerline that is aligned with an axis of the vertical track. The path of one or more of the massage heads crosses the centerline of the carriage. For example, the center massage head 1044 of massage device 1000 moves on a path that crosses the centerline 1033 of carriage 1030. The massage heads of massage device 1200 also move along such a path. For example, carriage 1230 includes lateral sides 1231 and a centerline 1233, which is shown as a dashed line in FIG. 13. The centerline 1233 is equidistant from the lateral sides. As shown by the elliptical dashed lines, which represent the respective paths of the upper massage heads 1244, both of these massage heads cross over the centerline. This motion that crosses the centerline is particularly effective for massaging muscles in limbs as tension is often present in the center of the muscle. Further, this path is different from the paths of many massage components designed for use with muscles in a person's back, where a gap is intentionally included between the paths of opposing massage heads in order to leave room for the user's spine.

In certain embodiments as otherwise described herein, the carriage includes a fabric that covers the massage heads included in the massage component. For example, carriage 1030 includes a fabric cover 1039 disposed over the massage heads 1044. Likewise, carriage 1230 includes a fabric cover 1239 that is disposed over the massage heads 1244. The cover prevents the massage heads from coming into direct contact with a user and possibly rubbing the user's skin. The cover also protects the components of the actuator and hides any possible pinch points.

In certain embodiments, the carriage includes a vibration motor. For example, the carriage may include an eccentric rotating mass vibration motor as described above.

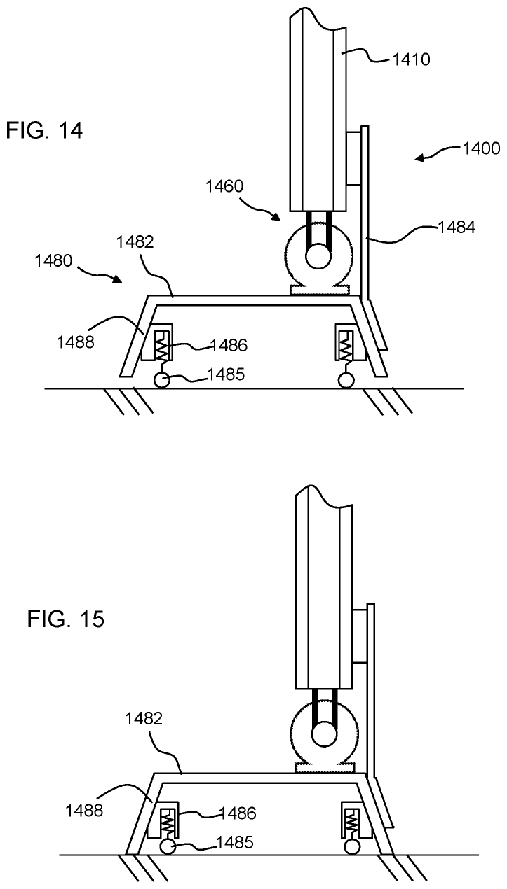

In certain embodiments as otherwise described herein, the vertical leg massager further includes a base and the vertical track is supported by the base. For example, massage device 1400, shown in FIGS. 14 and 15, includes base 1480 that has a platform 1482 that forms an area for a user to stand and that supports an electric motor of the drive 1460. The base also includes a support column 1484 that structurally supports the track 1410. In particular, track 1410 is attached to an upper end of support column 1484.

In certain embodiments as otherwise described herein, the base includes rollers to allow movement of the base. In some embodiments, the base includes a support structure, and the rollers are mounted on springs such that a downward force applied to the base depresses the springs and places the support structure in contact with an underlying surface. For example, base 1480 includes rollers 1485 that are mounted to a support structure 1488 via springs 1486. When a force is applied to the platform 1482 of the base, the springs 1486 compress bringing support structure 1488 into contact with an underlying surface, such as the floor, as depicted in FIG. 15.

In certain embodiments as otherwise described herein, opposing upper and lower ends of the vertical track include mounting feet for securing the vertical track to a vertical support structure. For example, massage device 100 in FIGS. 1-3 includes feet 180 at both the upper end and lower end of vertical track 110. The feet secure the track to a vertical support structure, such as a wall.

In certain embodiments as otherwise described herein, the vertical leg massager further includes a controller having a user input. The controller is configured to operate the drive in order to move the carriage along the vertical track.

In certain embodiments as otherwise described herein, the controller includes a control panel for operating the drive or inputting user preferences for operation of the drive and/or the massage component. A control panel allows for a large number of user inputs from a single fixed location. In some embodiments, the control panel is disposed at an upper end of the vertical track. In other embodiments, the control panel is disposed on a stand next to the track, or in another location. In some embodiments, the control panel includes a plurality of physical switches for inputting information into the controller, or controlling the drive or massage component. In other embodiments, the control panel includes one or more touch screens for receiving control commands from the user. In certain embodiments, the controller includes a control panel with a touch screen that forms the user input, where the control panel is disposed at an upper end of the vertical track. Such an embodiment is shown in FIG. 1, where massage device 100 includes a controller 190 including a control panel 191 disposed at the upper end of vertical track 110.

In certain embodiments as otherwise described herein, the controller includes a handheld remote. In some embodiments, the remote is on a tether. In other embodiments, the remote includes a wireless transceiver configured to communicate with a corresponding transceiver associated with the drive and/or massage component. In some embodiments, the remote includes a limited number of user inputs. By providing only a limited number of inputs on the remote, the user can control key functions of the massage device simply, or even by touch and without looking at the device. For example, in some embodiments, the remote includes a limited number of buttons that provide tactile feedback when activated. Examples of such buttons include: an up button that controls the drive to move the carriage up, a corresponding down button, an isolation button configured to hold the carriage in place or move the carriage up and down through a small height range, for example no more than 4 inches, no more than 3 inches, or no more than 2 inches, a reciprocate button configured to move the carriage up and down over the entire path of the track, and an off button to stop the carriage and any moving massage heads.

A massage device including a controller with a remote is shown in FIG. 1. In addition to control panel 191, controller 190 of massage device 100 also includes remote 193, which is attached to the device by a tether 194. Remote 193 includes two inputs 195 in the form of switches provided by push-buttons. In particular, the inputs include a button to control the drive for moving the carriage up and a button to control the drive for moving the carriage down.

In certain embodiments as otherwise described herein, the controller includes a memory for storing instructions and a processor to carry out the instructions. For example, in some embodiments the controller includes instructions for carrying out a massage sequence. The massage sequence can include various movements of the carriage along the track, or movements of any massage heads included in the massage component, as will be appreciated by those of ordinary skill in the art. For example, in certain embodiments including massage heads, the massage sequence includes instructions for moving the massage heads in different ways, for example in a tapping, kneading or rolling motion. In some embodiments the massage sequence includes reciprocating the carriage between upper and lower limits. In some embodiments, the upper and lower limits are input by the user, in other embodiments, a target area is input by the user and the upper and lower limits of the reciprocation are pre-programmed. For example, the user inputs a target area and the controller operates the drive to reciprocate the carriage within a 3 inch range surrounding the target area.

In certain embodiments, the massage device includes electrical connections between the controller and components of the drive, such as an electric motor. In some embodiments, these electrical connections are hidden as will be appreciated by those of ordinary skill in the art, for example by passing through conduits within the track. In other embodiments communication between the controller the drive is carried out through a wireless data connection.

Another aspect of the present disclosure is a massage method comprising providing a vertical massager including a vertical track, a carriage coupled to the vertical track, a massage component disposed on the carriage, and a drive connected to the carriage and configured to move the carriage along the vertical track. The method further includes pressing a leg of a standing user against the massage component and operating the drive so as to move the carriage along the vertical track and massage the leg.

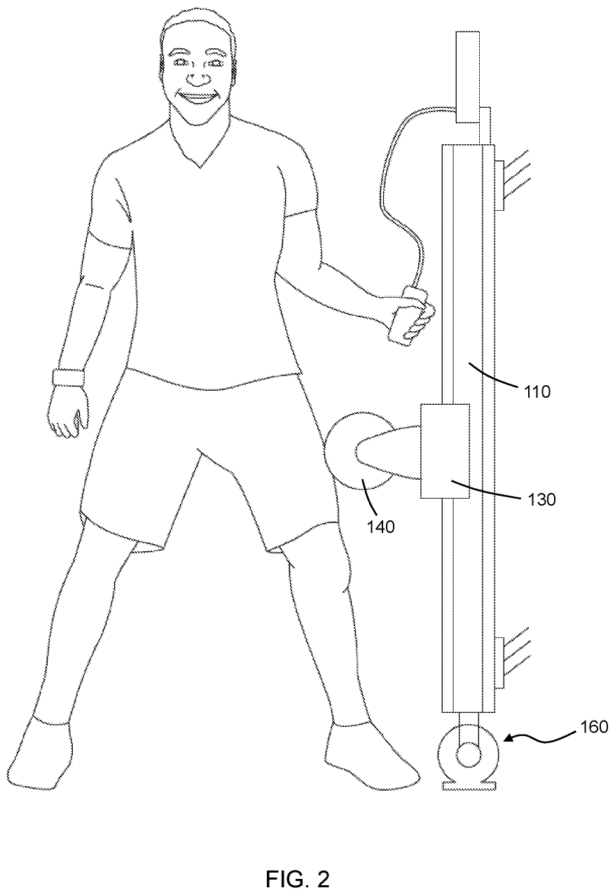

In certain embodiments as otherwise described herein, the massage component includes a cylindrical roller coupled to the carriage, and operating the drive causes the cylindrical roller to roll against the leg of the user. For example, FIG. 2 shows a user pressing his quadriceps into a roller 142 of massage component 140. Using remote 193, the user operates drive 160 to move carriage 130 and roller 142, which results in the roller 142 rolling against the user's quadriceps. In other embodiments, the user presses other body parts against the massage component, such as the calf, hamstring, IT band, hip, back or arm.

In certain embodiments as otherwise described herein, the massage component includes an actuator and a first massage head coupled to the actuator, and the massage method further includes operating the actuator to move the first massage head on a path against the leg of the user. In other embodiments, the method includes pressing another body part against the massage component and operating the actuator to move the massage head on a path against the other body part.

In certain embodiments the method includes operating the drive directly using the inputs of a controller. For example, in some embodiments, the method includes moving the carriage up by activating a corresponding up button on the controller and moving the carriage down by activating a corresponding down button on the controller. In other embodiments, the method includes moving the carriage through an automated massage sequence stored in a memory of the controller.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

What is claimed is:

1. A vertical massage device comprising:
a vertical track;
a carriage coupled to the vertical track;
a massage component disposed on the carriage; and
a drive connected to the carriage and configured to move the carriage along the vertical track.

2. The vertical massage device according to claim 1, wherein the track includes at least one rail, and the carriage includes rollers that secure the carriage on the rail and allow rolling interaction between the carriage and the rail as the carriage moves along the track.

3. The vertical massage device according to claim 1, wherein the track includes a rod and the carriage includes an enclosure surrounding the rod.

4. The vertical massage device according to claim 1, wherein the drive includes an electric motor that imparts movement of the carriage along the track.

5. The vertical massage device according to claim 4, wherein the drive includes:
a wheel coupled to the electric motor and configured to be rotated by the electric motor; and
a belt or chain engaging the wheel and disposed in a loop that spans the height of the vertical track,
wherein the carriage is mounted on the belt or chain so as to move up or down along the vertical track as the belt or chain is driven by rotation of the wheel.

6. The vertical massage device according to claim 1, wherein the massage component includes a roller that is rotatably coupled to the carriage.

7. The vertical massage device according to claim 6, wherein the roller is freely rotatable.

8. The vertical massage device according to claim 6, wherein the roller includes an outer layer formed of a complaint first material that surrounds an inner core formed of a second material.

9. The vertical massage device according to claim 6, wherein the roller includes a sheathing of fabric.

10. The vertical massage device according to claim 1, wherein the massage component includes:
an actuator; and
a first massage head coupled to the actuator, wherein the actuator is configured to move the first massage head in a path with respect to the carriage.

11. The vertical massage device according to claim 10, wherein the carriage includes opposing lateral sides and a centerline that is aligned with an axis of the vertical track, and wherein the path of the first massage head crosses the centerline of the carriage.

12. The vertical massage device according to claim 10, wherein the actuator includes a motor that imparts motion to the first massage head.

13. The vertical massage device according to claim 1, wherein opposing upper and lower ends of the vertical track include mounting feet for securing the vertical track to a vertical support structure.

14. The vertical massage device according to claim 1, further comprising a controller including a user input and being configured to operate the drive in order to move the carriage along the vertical track.

15. The vertical massage device according to claim 14, wherein the controller includes a handheld remote.

16. The vertical massage device according to claim 14, wherein the controller includes a control panel with a touch screen that forms the user input, and wherein the control panel is disposed at an upper end of the vertical track.

17. A massage method comprising:
providing a vertical massage device including:
a vertical track,
a carriage coupled to the vertical track,
a massage component disposed on the carriage, and
a drive connected to the carriage and configured to move the carriage along the vertical track;
pressing a leg of a standing user against the massage component; and
operating the drive so as to move the carriage along the vertical track and massage the leg of the user.

18. The method according to claim 17, wherein the massage component includes a cylindrical roller coupled to the carriage, and
wherein operating the drive causes the cylindrical roller to roll against the leg of the user.

19. The method according to claim 17, wherein the massage component includes:
an actuator, and
a first massage head coupled to the actuator; and
wherein the method further comprises operating the actuator to move the first massage head on a path against the leg of the user.

20. The method according to claim 17, further comprising operating the drive using a controller.
